(19) United States
(12) Patent Application Publication
(10) Pub. No.: US 2008/0106564 A1
(43) Pub. Date: May 8, 2008

(54) Method For Reducing Print-Density Variations In Printers, Particularly In Inkjet Printers

(75) Inventors: Lior Lifshitz, Maoz Zion (IL); Pavel Nosko, RaAnana (IL)

Correspondence Address: Martin D Moynihan;PRTSI, Inc., P O Box 16446, Arlington, VA, 22215, US

(73) Assignee: Jemtex Ink Jet Printing Ltd., Lod (IL)

(21) Appl. No.: 11/632,065

(22) PCT Filed: Jul. 12, 2005
(86) PCT No.: PCT/IL05/00737

§ 371 Date: Jan. 10, 2007

Related U.S. Application Data
(60) Provisional application No. 60/586,712, filed on Jul. 12, 2004.

(51) Int. Cl. B41J 2/205

(52) U.S. Cl. 347/15

(57) ABSTRACT

A method of reducing print-density variations in printers, particularly multi-deflection continuous-jet printers, including printing elements arrayed along the X-axis for printing on a substrate moving relative to the printing elements along the Y-axis. The method includes controlling the printer to print a test pattern having a plurality of strips extending along the X-axis, wherein the gray-level of each printed strip is the same along the X-axis, but varies from one strip to the next along the Y-axis; analyzing the printed test pattern to detect gray-level variations in the printed strips; preparing a density correction table of gray-level corrections for each X-coordinate; and controlling the printing elements in accordance with the density correction table to reduce the detected gray-level variations.

### FIELD AND BACKGROUND OF THE PRESENT INVENTION

The present invention relates to a method for reducing print-density variations in printers. The invention is particularly useful in inkjet printers as described in our prior U.S. Pat. Nos. 5,969,733, 6,003,980 and 6,106,107, and International Applications PCT/IL02/00346, filed May 2, 2002 (International Publication WO02/090119, published Nov. 14, 2002), and PCT/IL03/00988, filed Nov. 24, 2003 (International Publication WO2004/048099, published Jun. 10, 2004), the contents of which are hereby incorporated by reference. The invention is therefore described below particularly with respect to such printers, but it will be appreciated that the invention could also be used in other types of printers.

Inkjet printers are based on forming drops of liquid ink and selectively depositing the ink drops on a substrate. The known inkjet printers generally fall into two categories: drop-on-demand printers, and continuous-jet printers. Drop-on-demand printers selectively form and deposit the inkjet drops on the substrate as and when demanded by a control signal from an external data source; such systems typically use nozzles having relatively large openings, ranging from 30 to 100 μm. Continuous-jet printers, on the other hand, are stimulated by a perturbation device, such as a piezoelectric transducer, to form the ink drops from a continuous inkjet filament at a rate determined by the perturbation device. The drops are selectively charged and deflected to direct them onto the substrate according to the desired pattern to be printed.

Continuous-jet printers are divided into two types of systems: binary, and multi-level. In binary systems, the drops are either charged or uncharged and, accordingly, either reach or do not reach the substrate at a single predetermined position. In multi-level systems, the drops can receive a large number of charge levels and, accordingly, can generate a large number of print positions.

As there is a relative motion between the print head and the substrate, each nozzle repeatedly prints short line sections of data. For each graphic combination of such a line section, there is a corresponding combination of charging voltages, designed to bring each droplet to its required position on the substrate. The object of many patents is to improve the design of these voltage combinations in order to improve the printing accuracy. Because of electrostatic and aerodynamic interactions between the drops, this task is very complicated. U.S. Pat. Nos. 4,054,882, 4,395,716, 4,525,721, 4,472,722 all deal with methods for the separation and staggering of drops in the air, in order to minimize the interactions between them. However, because of these interactions and other factors in the system, it is very difficult to avoid errors in droplet placement, resulting in printing errors on the substrate.

The process of drop formation depends on many factors associated with the ink rhelogy (e.g. viscosity, surface tension), the ink flow conditions (e.g. jet diameter, jet velocity), and the characteristics of the perturbation (e.g. frequency and amplitude of the excitation). Typically, drop formation is a fast process, occurring in the time frame of a few microseconds. However, because of possible variations in one or more of the several factors determining the drop formations, variations are possible in the exact timing of the drop break-off. These timing variations can cause incorrect charging of drops if the electrical field responsible for drop charging is turned-on, turned-off, or changed to a new level, during the drop break-off itself. Therefore it is necessary to keep the data pulse precisely in-phase relative to the drop break-off timing, in order to obtain accurate drop charging and printing.

Another type of commonly-occurring printing error is incorrect velocity of the ink drops such that the ink drop is not deflected to its proper position on the substrate. Drop velocity (or jet speed) errors may be produced by many different factors, such as those associated with the ink rhelogy and/or the ink flow conditions. Such errors may be corrected by changing the drop charging voltage applied to the ink drops since the amount of deflection experienced by the ink drops before impinging the substrate depends on the drop velocity, the voltage applied to the deflector plates electric field, and the drop charge.

A still further problem in inkjet printing is the formation of satellites in the stream of drops. Satellites are characterized by volumes which are much smaller (typically by more than one order of magnitude) than the basic drop volume, i.e. the volume within the drop desired to be printed. In the usual capacitively charged configurations, satellites carry a charge similar to the charge carried by the basic drop. The acceleration experienced by charged drops in an electrical field is inversely proportional to their masses. Since the mass of the satellite is much smaller than the mass of the basic drop, satellites will experience a much stronger acceleration inside the deflection field, and may therefore impinge against the deflecting plates. This could result in an electrical breakdown condition or other malfunction of the printer.

Many techniques have been developed for eliminating or reducing the above problems encountered in inkjet printing, as described, for example, in the above-cited patents and International Applications. International Application PCTIL2003/00098 describes a split-segment printing technique, wherein the multi-level charging and deflecting plates of the nozzles are controlled to deflect the ink drops of each nozzle to selected locations within a line section for each nozzle, which line section includes two non-contiguous deposit zones to receive ink drops from the respective nozzle, separated by a non-deposit zone not to receive ink drops from the respective nozzle.

However, another problem which has not yet been successfully addressed, and which is particularly involved with multi-deflection continuous-jet printers, is the problem of density variations in the printer output. Such density variations are caused by errors which are specific to multi-deflection continuous-jet printers. The human eye is very sensitive to such variations since they are often periodical and have considerable contrast. While drop-on demand printers have similar problems, they usually result from specific correctable errors in the nozzles, such as clogged nozzles, and therefore can be more easily corrected. In multi-deflection continuous-jet printers, however, density variations may result from a combination of a large number of factors, such as different drop velocity or volume for different nozzles, error in drop deflection for complete sections or individual drops, etc.

The problem of reducing variations in printer density has been addressed by many prior patents, as shown for example in U.S. Pat. Nos. 5,353,053, 5,276,459, 6,508,531 and 6,760,056. In general, the prior art systems address the problem of density variations by analyzing the print density, generating error signals, and using the error signals in feedback corrections of the print head. However, in multi-deflection continuous-jet printers it is virtually impossible to relate density variations to the behavior of individual drops because of the complexity of the multiple-deflection continuous-jet printing process. Moreover, even if the inkjet nozzles are individually calibrated and corrected for errors in drop speed, drop formation, drop deflection, data signal phase, etc., density variations may still arise as a result of errors in the direction of substrate motion with respect to the printing nozzles. Such prior art methods, therefore, are generally not particularly suitable for multi-deflection continuous-jet printers, or if applied to such printers, would involve extremely complicated and costly systems to implement.

### OBJECTS AND BRIEF SUMMARY OF THE PRESENT INVENTION

An object of the present invention is to provide a method for reducing print-density variations in printers having advantages in the above respects. Another object of the present invention is to provide a method particularly useful for reducing print-density variations in multi-deflection continuous-jet printers.

According to one aspect of the present invention, there is provided a method of reducing print-density variations in printers, including printing elements arrayed along the X-axis for printing on a substrate moving relative to the printing elements along the Y-axis, the method comprising: controlling the printer to print a test pattern including a plurality of strips extending along the X-axis, wherein the gray-level of each printed strip is the same along the X-axis, but varies from one strip to the next along the Y-axis; analyzing the printed test pattern to detect gray-level variations in the printed strips; preparing a density correction table of gray-level corrections for each X-coordinate; and controlling the printing elements in accordance with the density correction table to reduce the detected gray-level variations.

As will be described more particularly below, the method of the present invention thus identifies the density variations by their printed positions on the substrate, and then modifies the printing operation to eliminate or reduce such density variations by working on this data rather than on the printing elements.

According to further features in the described preferred embodiments, the correction table of gray-level corrections includes a delta value for each X-coordinate and gray level. Also, the printer is controlled to print the test pattern such that the plurality of strips vary in gray level from zero to saturation along the Y-axis.

The invention is particularly useful with respect multi-deflection continuous-jet printers in which the printing elements are inkjet nozzles having a side shifting mechanism which is used for printing the test pattern of strips.

According to another aspect of the present invention, therefore, there is a provided a method of reducing print-density variations in inkjet printers, including a plurality of inkjet nozzles arrayed along the X-axis for printing on a substrate moving relative to the nozzles along the Y-axis, the method comprising the operations: controlling the inkjet printer to print a test pattern including a plurality of strips extending along the X-axis, wherein the gray-level of each printed strip is the same along the X-axis but varies from one strip to the next along the Y-axis; analyzing the printed test pattern to detect gray-level variations in the printed strips; preparing a density correction table of gray-level corrections for each X-coordinate; and controlling the inkjet nozzles in accordance with the density correction table to reduce the detected gray-level variations.

In the described preferred embodiments, the printer is a multi-deflection continuous-jet printer; the test pattern is printed and analyzed for each color; and a density correction table is prepared for each color.

According to a still further feature in the described preferred embodiments, in analyzing the printing test pattern, each of the printed strips is tested for a saturated condition; and where a saturated condition is found to be present, an extrapolated value is included in the density correction table for the respective X-coordinate. This feature enables an accurate correction table to be prepared even where there is saturation, since there may be a case where under one set of printing conditions there will be saturation, while under another a different set of printing conditions, there will be no saturation.

The foregoing operations for correcting for print-density variations are preferably performed digitally after the printer is corrected by analog signals for nozzle position errors, angular deflection errors, and phase-shift errors.

As will be described more particularly below, the above processing steps may be performed independently of the printing device, and therefore the corrections may be effected completely off-line on any image to be printed, and during a single pass of the substrate with respect to the printing elements.

Further features and advantages of the invention will be apparent from the description below.

### BRIEF DESCRIPTION OF THE DRAWINGS

The invention is herein described, by way of example only, with references to the accompanying drawings, wherein

FIG. 1 is a diagram illustrating a multi-deflection continuous-jet printer with respect to which the present invention is particularly useful;

FIG. 2 diagrammatically illustrates one manner of analyzing, calibrating and correcting certain types of printing errors in the printer of FIG. 1;

FIG. 3 is a block diagram more particularly illustrating one form of apparatus, as described in the above-cited International Application PCT/IL02/00346 which may be controlled in accordance with the present invention for reducing density variations;

FIG. 4 diagrammatically illustrates a split-segment type printer constructed in accordance with the above-cited International Application PCT/IL03/00988, which may be operated in accordance with the present invention for reducing density variations.

FIGS. 5a and 5b illustrate one manner of operating the printer of FIG. 4 to reduce density variations in accordance with the present invention;

FIG. 6 is a flow chart illustrating certain analog calibrations which may be effected when calibrating the printer of FIG. 3;

FIG. 7a diagrammatically illustrates an example of the target image that is printed during the effecting of the analog calibrations of FIG. 6;

FIGS. 7b-7e show the pair of the target image lines of FIG. 7 printed with the nozzles having different combinations of the correct/incorrect position and normal/wider fan openings, and also the lines printed with the nozzle having phase shift between the data signal and the drop formation signal;

FIG. 8a is a diagram illustrating the placement of the ink drops at their correct positions when the printed media is at the proper distance from the nozzles; whereas FIG. 8b illustrates the ink drops misplaced from their correct positions when the printed media is not precisely at its proper position with respect to the nozzles;

FIG. 9 is a block diagram illustrating the main operations in reducing print-density variations in accordance with the present invention;

FIG. 10 illustrates an idealized test pattern which should be ideally printed by the side shifting mechanism in the apparatus of FIG. 3;

FIG. 11 illustrates an actual test pattern which is printed by the side-shifting mechanism in the apparatus of FIG. 4, illustrating the print-density variations in the test pattern;

FIG. 12 is a typical density correction table of gray-level corrections for each X-coordinate prepared in accordance with the method of the present invention;

FIG. 13 illustrates the correction image produced by utilizing the density correction table of FIG. 12 for controlling the print elements in order to correct for the detected density variations;

FIG. 14a illustrates an example of a gray-level image, and the corresponding gray-level profile in the test pattern of FIG. 11, particularly showing the density variations therein;

FIG. 14b illustrates the example of the gray-level image of FIG. 14a after correction in accordance with the density correction table of FIG. 12 and the correction image of FIG. 13;

and FIG. 15 is a flow chart illustrating the manner in which the method of the present invention accommodates the possibility of color saturation when reducing print-density variations in accordance with the present invention.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF A PREFERRED EMBODIMENT

### The Multi-Deflection Continuous-Jet Printer

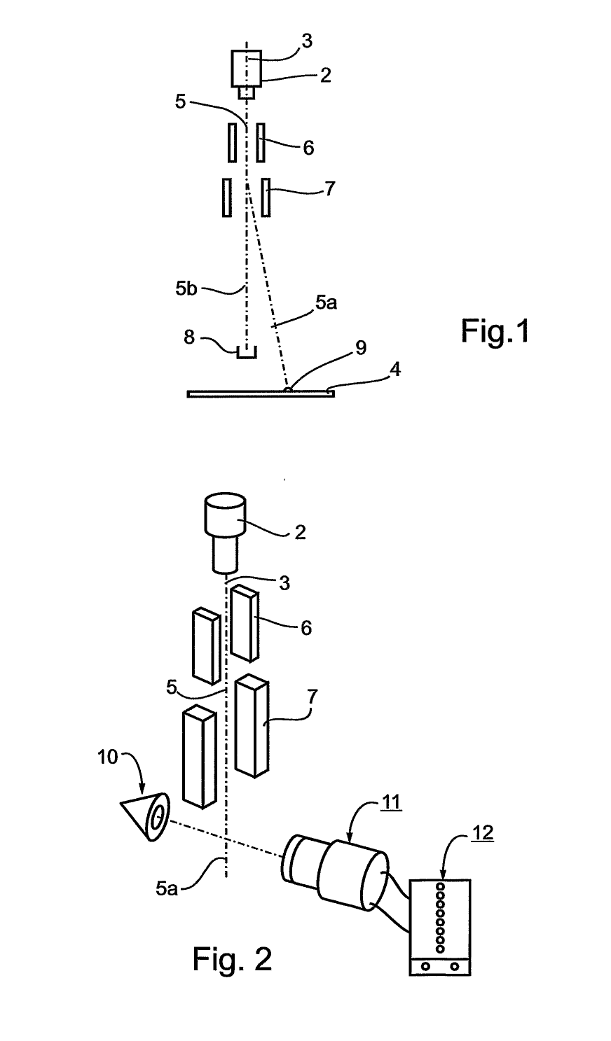

FIG. 1 diagrammatically illustrates a multi-deflection continuous-jet printer of a conventional construction. It includes a nozzle 2 containing a reservoir of liquid ink directing the liquid ink in the form of a continuous jet along the nozzle axis 3 towards a substrate 4 for deposition thereon according to the desired pattern to be printed. Nozzle 2 includes a perturbator, such as a piezoelectric transducer, which converts the jet of liquid ink into a continuous stream of liquid ink drops 5 initially directed along the nozzle axis 3 towards the substrate 4, but selectively deflected according to the desired pattern to be printed on the substrate. The selective deflection of the liquid ink drops 5 is effected first by a pair of charging plates 6 straddling the nozzle axis 3, and then by a pair of deflecting plates 7 also straddling the nozzle axis. The charging plates 6 selectively charge the drops 5 at the instant of drop break-off from the jet filament, and the deflecting plates 7 deflect the charged drops with respect to the nozzle axis 3. A gutter or catcher 8 between the deflecting plates 7 and the substrate 4 catches those liquid ink drops which are not to be deposited on the substrate 4. The so-caught drops are circulated back to the reservoir of the respective nozzle 2.

In the multi-level deflection printer illustrated in FIG. 1, the charging plates 6 apply a multi-level charge to the drops 5 exiting from the nozzle 2 such that the deflecting plates 7 deflect the drops 5a to be received on the substrate 4 to any one of a plurality of locations thereon, as shown by print dots 9, according to the charge applied to the respective drops, whereas the drops 5b not to reach the substrate 4 are caught in the gutter 8.

The drops 5a to be deposited on the substrate 4 are charged to a selected one of a plurality of charge levels of one polarity; whereas the drops 5b not to be printed on the substrate 4 are uncharged. Thus, as shown in FIG. 1, the substrate 4 will receive, as printed dots, the charged drops, charged to a selected level of one polarity, which drops will be deposited on the substrate 4 to produce the printed dots 9 according to the selected charge. On the other hand, the drops which are uncharged are caught by the gutter 8 before reaching the substrate 4, as shown by drops 5b.

FIG. 2 illustrates one technique for utilizing the uncharged free-fall liquid ink drops for calibration purposes. The calibration technique illustrated in FIG. 2 utilizes a stroboscopic illumination unit, generally designated 10, and one or more cameras, generally designated 11, for capturing, in free flight, the uncharged free-fall drops to be printed, shown at 5a, i.e., those not charged by the charging plates 6 or deflected by the deflecting plates 7. The stroboscopic illumination unit 10 may be an LED (light emitting diode) unit having the ability to strobe at a frequency equal to the frequency of the generation of the ink drops 5; and the camera unit 11 preferably incorporates a CCD camera and an imaging lens to display the drops viewed by the camera in a display unit 12, and/or to provide an input to a frame grabber for digital image processing in a computer. For example, the liquid ink drops 5 may be generated at a rate of 30 kHz, and the illumination unit 10 may be strobed with the same frequency, to enable the camera unit 111 to capture the drops in free flight and to display them in the display unit 12, and/or to process data regarding them in a computer.

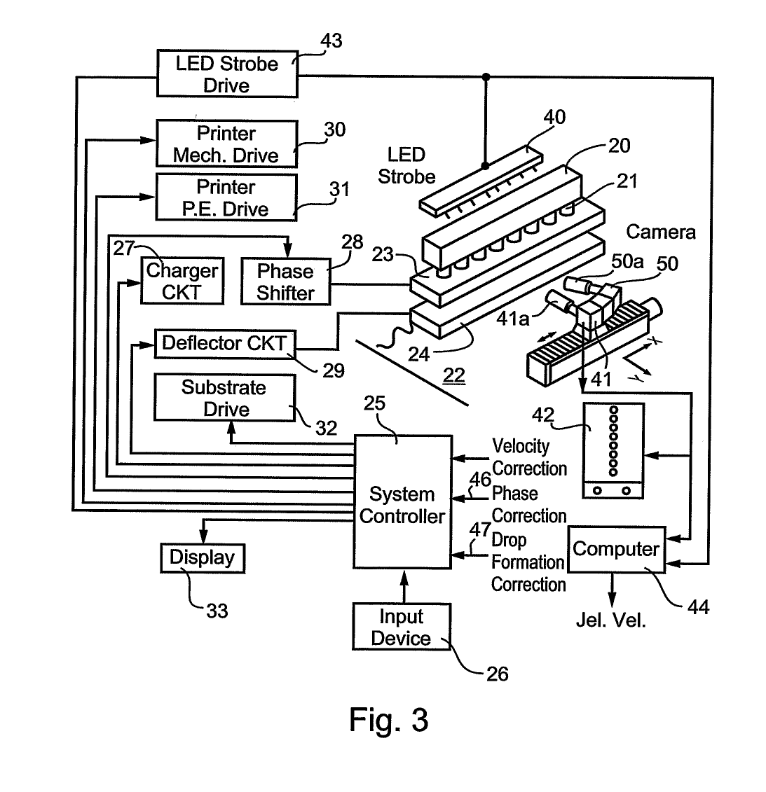

FIG. 3 is a block diagram illustrating one manner for performing the basic calibration operations of the illustrated printer. The illustrated printer includes a printer head 20 mounting a line of nozzles 21 each discharging a stream of liquid ink drops towards a substrate 22 for deposition thereon according to a desired pattern to be printed. As briefly described above, the printer head 20 includes a reservoir of liquid ink and a piezoelectric perturbation device for producing a stream of liquid ink drops originally along the axis of the respective nozzle, but selectively charged by charging plates 23 and deflected by deflecting plates 24 according to the desired pattern to be printed on the substrate.

In FIG. 3, the overall operation of the apparatus is controlled by a system controller 25 according to the data inputted via an input device 26. The system controller 25 controls the charges applied to the charging plates 23 by means of a charger circuit 27 and a phase shifter circuit 28. Controller 25 also controls the charges to be applied to the deflector plates 24 via a deflector circuit 29. As further shown in FIG. 3, controller 25 further controls the printer mechanical drive 30, the printer electrical drive (e.g. the perturbation piezoelectric device) 31, the substrate drive 32, and a display 33.

For calibrating the apparatus, the system is provided with a stroboscopic illumination unit 40 incorporating unit 10 in FIG. 2 and a video imaging unit 41 incorporating unit 11 in FIG. 2. Illumination unit 40 may be an LED stroboscopic device having the ability to strobe at a frequency equal to the drop generation frequency; and the video imaging unit 41 may include one or more CCD cameras and one or more imaging optics capable of capturing the ink drops “on the fly” either upstream (for drop formation calibration) or downstream (for speed, alignment and phase calibration). Video imaging unit 41 displays the ink drops in a display 42, and/or digitally stores them and processes them with a frame grabber of a computer, to enable automatic calibration of the apparatus. The LED stroboscopic device 40 includes a drive, shown at 43, also controlled by the system controller 25.

As described earlier, an important condition for proper operation of the printer is the speed of the free-fall stream of ink drops, which can be observed and the velocity computed in real-time. The computation of the ink drop velocity may be done manually, e.g. by comparison with reference tables or diagrams, or can be computed automatically. FIG. 3 illustrates the inclusion of a computer 44 for making this computation automatically.

As further indicated above, printing errors resulting from variations in the drop formation can be corrected by adjusting the charging voltages applied to the charging plates 23 since the amount of deflection experienced by the ink drops depends not only on the drop velocity, but also on the voltage on the plates which determine the charging of the drops. Thus, the system controller 25 could include a manual (or automatic) input device 45 for controlling the charger circuit 27 to compensate for drop velocity errors or incorrect drop charging.

Printing errors, resulting from incorrect phasing between the charging pulses applied to the ink drops at the nozzles 21 and the ink drop break-off times, can be corrected by an input 46 to the system controller 25 controlling the phase shifter circuit 28.

The formation of satellites in the ink drops can be suppressed by an input 47 to the system controller 25 for controlling the piezoelectric perturbation drive 31. As described above, the perturbation device within the printer head 20 can be controlled so as to produce an optimum shape of the ink drops and with no, or substantially no, satellites.

FIG. 3 illustrates a second camera 50 having a sensor axis 50a at a predetermined angle to the axis 41a of camera 41. The outputs of the two cameras 41, 50 are fed to the system controller 25 which processes these outputs, together with the predetermined angle between the axes of the two cameras, to compute any deviation of the stream of ink drops from its respective nozzle axis (a) in the direction parallel to the row of nozzles 21 (X-axis offset), and (b) in the direction perpendicular to the row of nozzles (Y-axis offset). System controller 25 corrects the computed X-offset for a particular nozzle by controlling the charger circuit 27 to adjust the charging voltage applied to the charging plates 23 for the respective nozzle. System controller 25 corrects the computed Y-axis offset for a particular nozzle by adjusting the timing of the input data from the input device 26 applied by the system controller 25 to the respective nozzle.

It will thus be seen that the above-described multi-deflection continuous-jet printer enables the achievement of better print quality since it permits printing of segments by means of ink drops generated from different nozzles, from the same line or from different lines. Thus, the printing of each print segment may be “shared” between several nozzles.

### The Split-Segment Printer

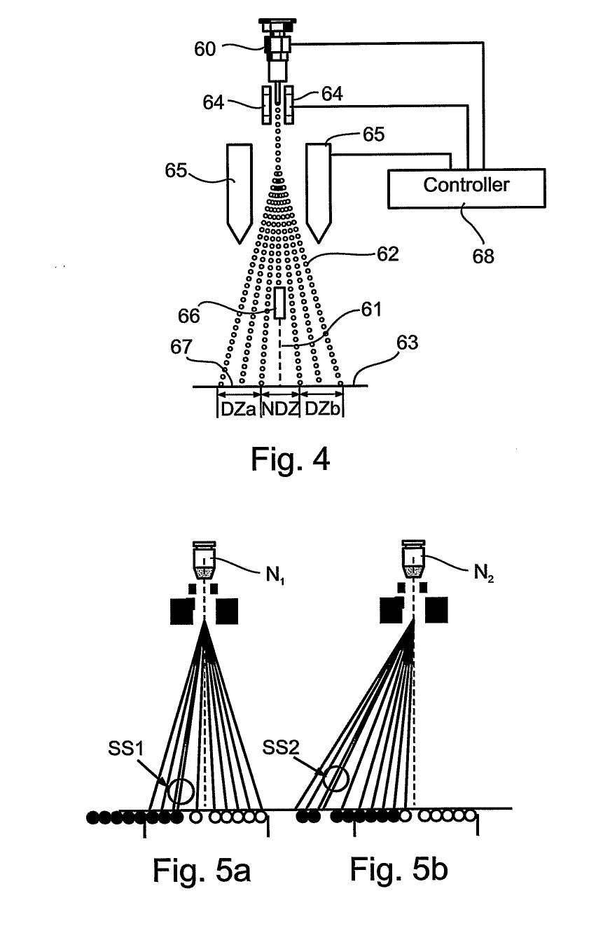

FIGS. 4, 5a and 5b illustrate a split-segment type printer as described in the above-cited International Application PCT/IL2003/00988, in which the multi-level charging and deflecting plates of the nozzles are controlled to deflect the ink drops of each nozzle to selected locations within a line section for each nozzle. The line section includes two non-contiguous deposit zones to receive ink drops from the respective nozzle, separated by a non-deposit zone not to receive ink drops from the respective nozzle.

Thus, as shown in FIG. 4, the nozzle 60 emits liquid ink drops 62 initially along its axis 61 towards the substrate 63, but the drops are deflected with respect to the nozzle axis by a pair of charging plates 64 and deflection plates 65 to selected locations within a line section 67 on the substrate 63 covered by the respective nozzle. Nozzle N further includes a gutter 66 for intercepting undeflected drops before reaching the substrate, which drops are recirculated to the ink reservoir for the nozzle. FIG. 4 also schematically illustrates the controller 68 for controlling the operation of the nozzle 60, particularly its perturbator (not shown), the charging plates 64, and the deflection plates 65, to deflect the ink drops of each nozzle to a selected location within the lines section 67 covered by the nozzle 60.

As shown in FIG. 4, line section 67 covered by nozzle 60 includes two non-contiguous deposit zones DZₐ, DZ_{b}, to receive ink drops from the nozzle, separated by a non-deposit zone NDZ not to receive ink drops from the nozzle. The non-deposit zone NDZ is aligned with the respective nozzle axis 61, and the deposit zones DZₐ, DZ_{b}, are located on opposite sides of the nozzle axis. The two deposit zones are generally, but need not be, equal and symmetric.

As further described in the above-cited International Patent Application PCT/IL2003/000988, the sharing of each printed segment between several nozzles enables print quality to be improved in another manner, namely by shifting a complete line of drops a given distance sidewise, while maintaining the data in place. FIGS. 5a, 5b illustrate an arrangement which may used to blur printing defects in this manner, namely by side-shifting a complete line of drops a given distance laterally without shifting the data, and changing the side shift when printing different lines. Print defects are directly linked to the structure of the drops fan. Since this side-shift is different from line-to-line, the defects position is also shifted, resulting in a significant blurring effect with respect to the defect, thereby improving the print quality. This is shown in FIGS. 5a and 5b, illustrating the same nozzle N controlled to produce a side shift SS₁ when printing one line (FIG. 5a) and a different side shift SS₂ when printing another line (FIG. 5b). The amount of shifting for each line may be designed to create a pattern that will further blur printing defects.

However, the fact that the printing of each segment may be shared between several nozzles can also produce variations in the print density which are difficult to correct by conventional techniques, particularly in single-pass printing. Thus, density variations along the X-axis (the axis in which the nozzles are arrayed), and perpendicular to the Y-axis (the axis of the substrate motion relative to the nozzles) may be the result of several factors including (a) different drop velocity or volume for different nozzles; (b) wrong or misplaced drop deflection for individual drops or for complete sections; (c) inaccurate reference substrate plane; (d) out-of-phase drops; (e) large skew jets; (f) drops striking the gutter, etc.

For further information as to the construction of the illustrated printers, reference is made to the above-cited patents and international applications incorporated herein by reference.

### Correction of Main Printing Errors

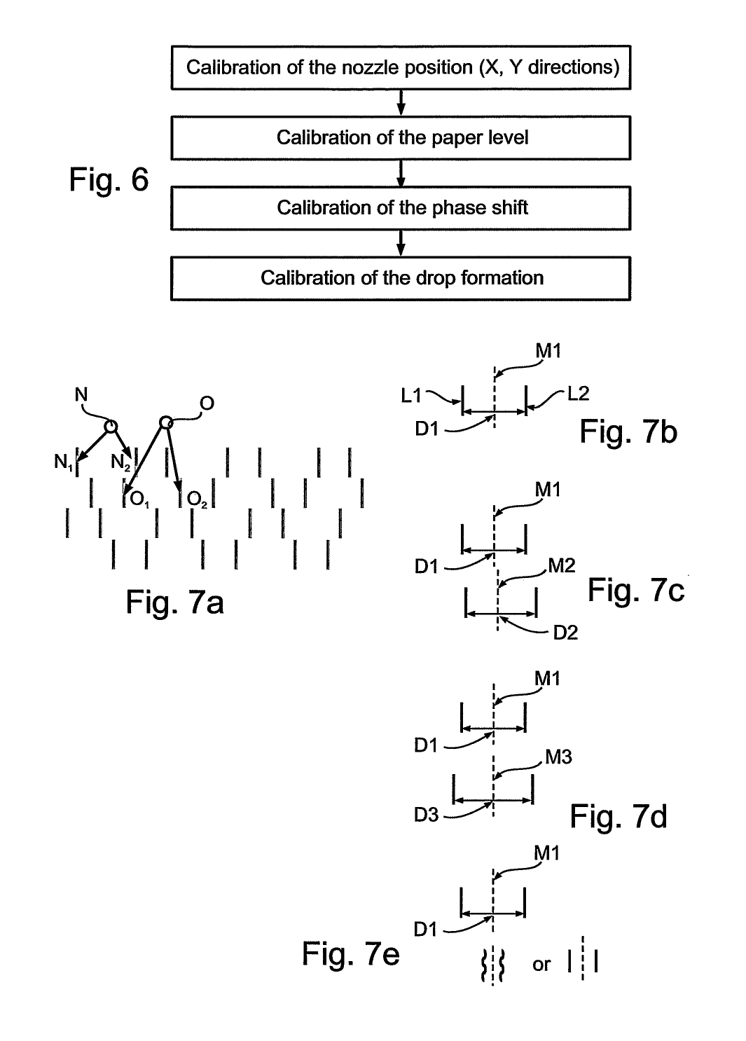

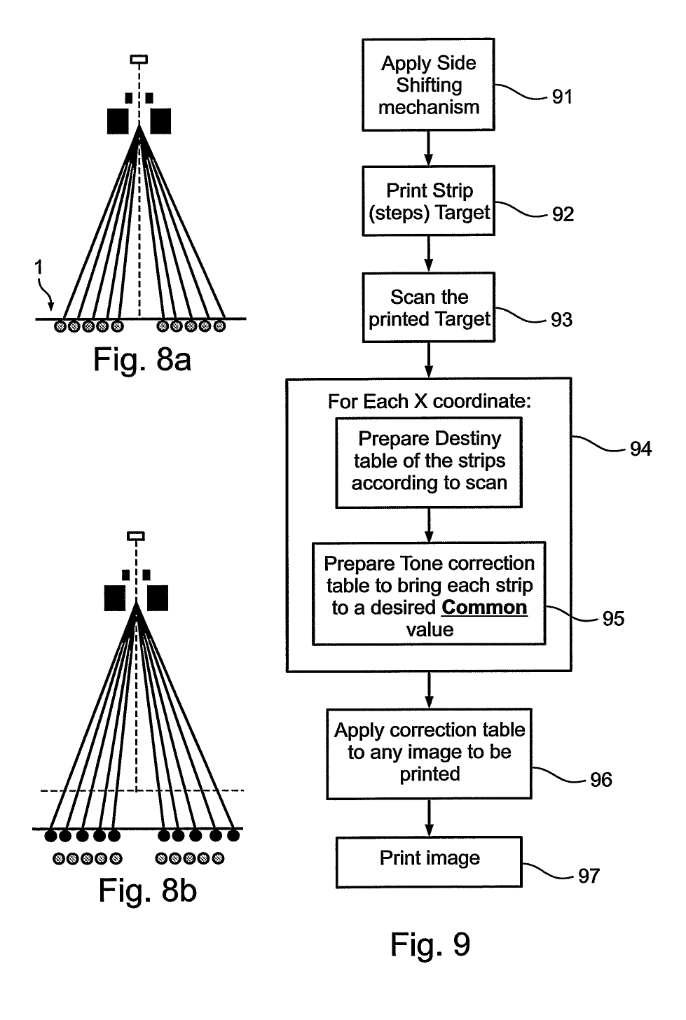

FIG. 6 is a block diagram illustrating one procedure that may be used for performing basic pre-calibration operations for the correction of the main printing errors. This calibration process involves calibrating the nozzle position, the paper level, the phase shift, and the drop formation, according to known techniques and sequences. As indicated above, this pre-calibration process brings the system to a printing state.

However, as indicated above, sometimes it is not enough to pre-calibrate the system as described above before printing since the initial prints may show density variations across the substrate motion direction, i.e. along the Y-axis. As also indicated above, these density variations have an adverse effect on the quality of the final print since the human eye is very sensitive to such density variations, especially if they are periodical. Some density variations, especially the major ones, can be related to specific nozzles, and therefore can be corrected by modifying the operation of the nozzles according to known procedures.

After the initial calibration of the printer as described above, a first target image is printed, as shown for example in FIG. 7. The printed image is designed so that each nozzle prints a graphic element such as to enable the identification of various problems. FIG. 7 illustrates an example wherein each nozzle prints a pair of lines with a predetermined position for each line. Thus, nozzle N prints a pair of lines N₁, N₂, whereas the next nozzle O prints a pair of lines O₁, O₂. The positions of the lines along the X and Y coordinates correspond to the position of the respective nozzle, and the quality of the lines indicates a properly set phase shift and drop formation. While the printed image illustrated in FIG. 7 by itself does not show density variations, it facilities the identification of various problems leading to density variations.

The first target image is captured using a digital capture device (e.g. scanner, digital camera, e.g. FIG. 3), and thus converted to a digital image file. The image file is analyzed by special software that determines the position of each of the printed elements and assigns them to specific nozzles.

The information from the captured print is used to identify the following problems:

1. Error in the position of all drops of certain nozzles. This position error is either in the motion direction, or across this direction, or in both directions. FIG. 7a shows the pair of the target image lines (L1, L2) printed with the nozzle having nominal positions and nominal fan openings as well as correct phase shift between the data signal and the drop formation signal. The printed elements appear as sharp straight parallel lines, with the middle line M1 at the nominal position and the correct separation D1. FIG. 7b shows the pair of the target image lines printed with the nozzle having an incorrect position and a wider fan opening. The middle line M2 is shifted from the nominal position, and the line separation D2 is larger than the nominal one.

Nozzles position errors are measured from the deviation of the target image's centerlines from their nominal positions, as can be seen in FIGS. 7a and 7b. The nozzle position is corrected by modifying the deflection of all drops according to the magnitude of the error. By this it is possible to apply an offset to the “nozzle position”. The deflection is modified by applying different charging voltages to all drops of specific nozzles, according to pre-calculated deflection tables.

2. Angular error in the deflection of all drops of certain nozzles. FIG. 7c shows the pair of the target image lines printed with the nozzle having the correct position and a wider fan opening. The middle line M3 is at the nominal position, and the line separation D2 is larger than the nominal one.

The angular errors may result from inaccurate angular calibration of specific nozzle, or from the global effects giving angular errors to all nozzles, for instance, caused by the imperfect geometry of the printed media. The errors are measured from the deviation the separation of the printed target image lines, as shown in FIGS. 7a and 7c. In the first case it is required to modify the angular deflection of specific nozzles. This is done by modifying the charging voltages applied to specific nozzles, in order to “open” or “close” the fan of drops. If the effect is global, it is possible to modify the virtual substrate level, which results in a global change to all nozzles as if the substrate position were modified.

3. Wrong phase shift between the data signal and the drop formation signal. FIG. 7d shows the pair of the target image lines printed with the nozzle incorrect phase shift. The printed elements appear as non-sharp irregular lines or parallel lines, but with significantly narrower separation. In multi-deflection continuous-jet printers, an analog data signal is applied to each drop during its formation. A timing difference between the two events results in incorrect deflection or no deflection at all. Non-appropriate phase shift may be caused e.g., by variation of the operation condition (temperature) over a long time period, and is detected from the printed target image, as shown in FIG. 7d. Phase shift calibration may be carried out for all nozzles that have this problem. The process of phase shift calibration consists of capturing images of drops while ejected from the nozzle. Bad phase shifts may thus be identified directly, and the correct shift can be calculated.

Some nozzles may be inherently unstable and demonstrate the above errors repeatedly. These nozzles should have their drop formation calibrated. This process consists of capturing images of drops during their formation. The formation parameters may be modified in the process, and optimized for the best performance.

After the first correction cycle (the analog corrections), the amount of density variations is reduced considerably.

### Correction of Residual Printing Errors

As indicated above, even after all analog corrections, there are still subtle variations in tone density or along the X-scan direction to which the human eye is highly sensitive, especially since they tend to be periodic. These errors can not be simply related to specific causes as they are the outcome of a large number of minor errors. A correction process is therefore effected which takes a different approach than the above-described analog corrections. This correction process handles the density variations based on their location within the printing space, and corrects the original image accordingly, without any reference to the origin of the errors.

Broadly speaking, this correction process takes a digital approach and involves the following operations: controlling the printer to print a test pattern including a plurality of strips extending along the X-axis, wherein the gray-level of each printed strip is the same along the X-axis, but varies from one strip to the next along the Y-axis; analyzing the printed test pattern to detect gray-level variations in the printed strip; preparing a density correction table of gray-level corrections for each X-coordinate; and controlling the printing elements in accordance with the density correction table to reduce the detected gray-level variations.

In the described preferred embodiments, the correction table of gray levels includes a delta value for each X-coordinate and gray level. In addition, the printer is controlled to print the test pattern such that the plurality of strips vary in gray level from zero to saturation along the Y-axis.

More particularly, this correction process involves the following operations:

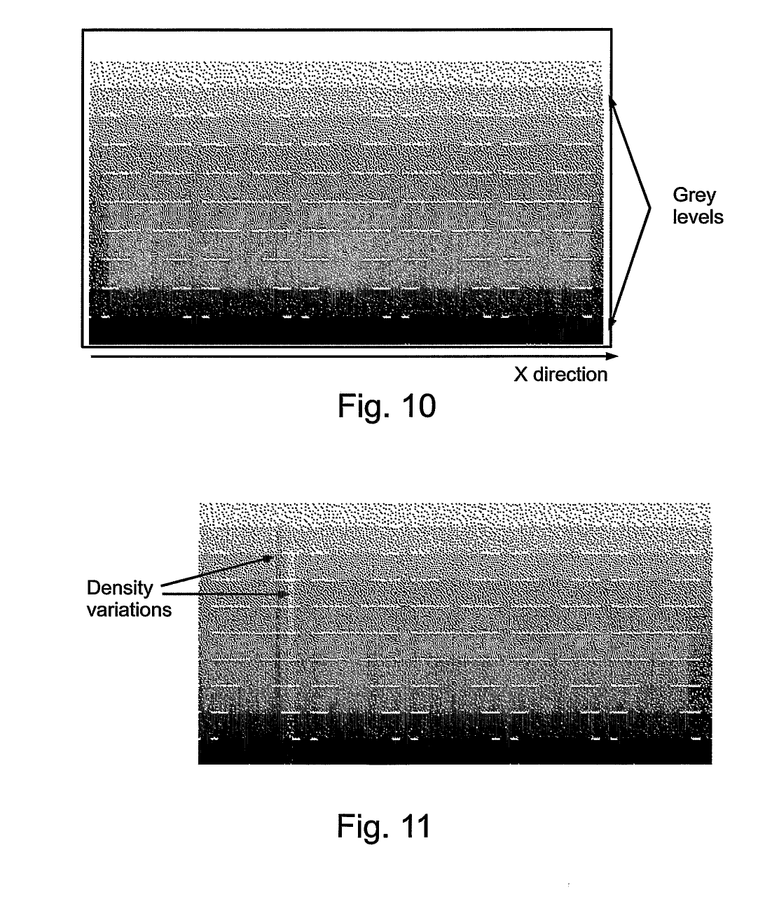

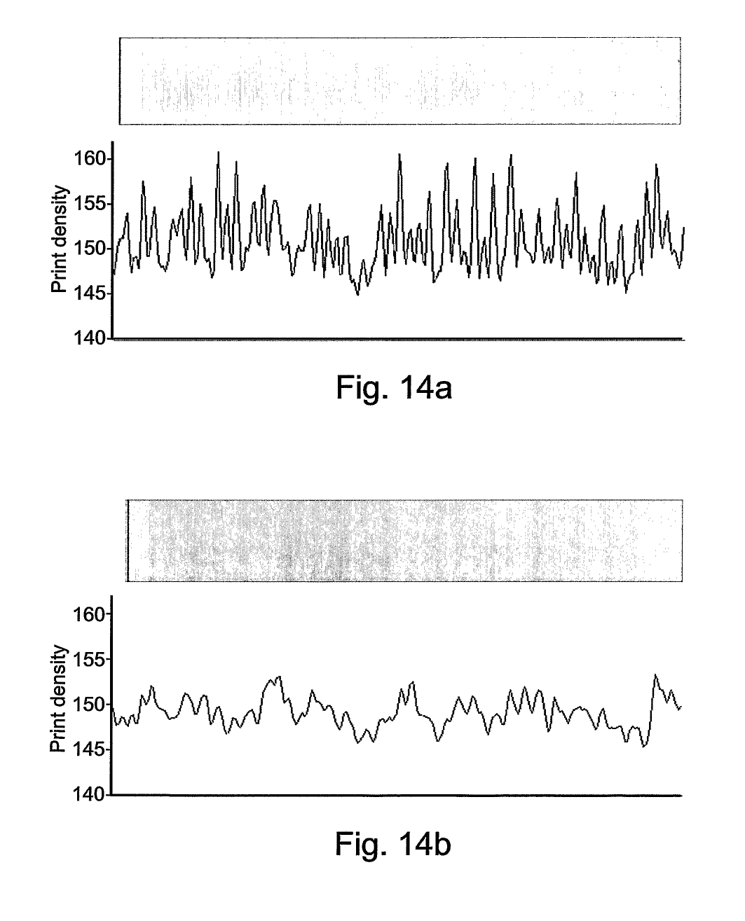

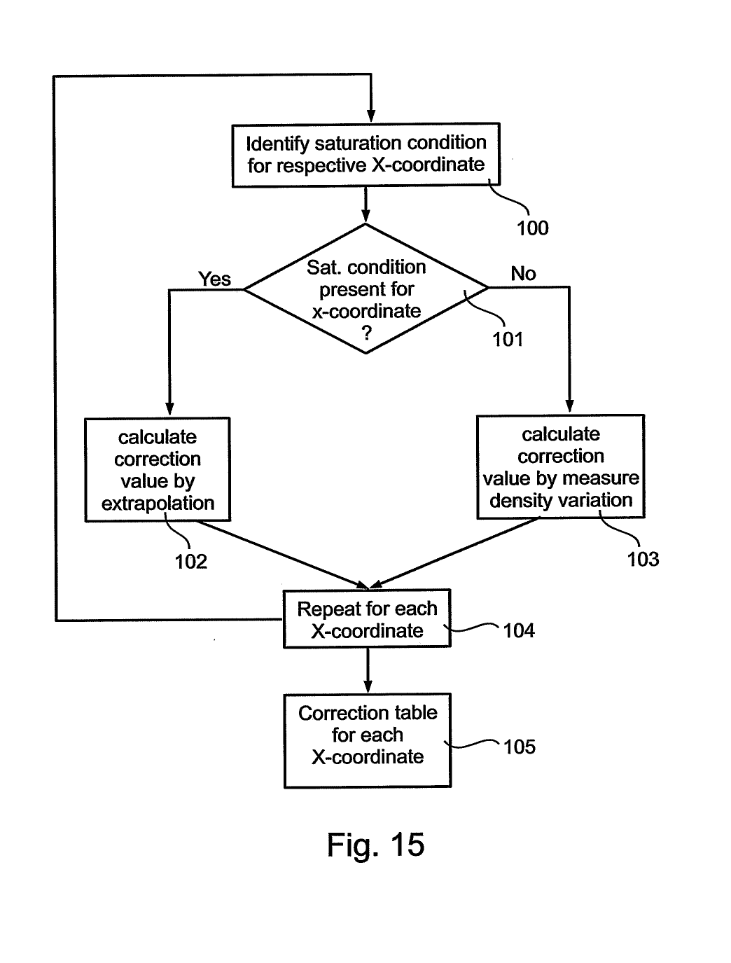

1. Printing the above-described test pattern (FIG. 10) using a technique that spreads and blurs any sharp density variations caused by various machine errors. Very often, when printing the test pattern, (or any other image file) the unwanted density variations may show a very sharp spatial profile, e.g., there are large differences in density over very short distances. These errors are more difficult to identify and correct. Multi-deflection continuous-jet printers allow spreading these variations so that they are less apparent and easier to correct. This can be done, for example, by modifying the deflection of complete lines of drops (side-shifting), without moving the actual image data, as described above and with respect to FIGS. 4, 5a and 5b. Another method for smoothing the printed image is by mixing drops from different nozzles on any position on the substrate, as also described in the above-cited International Application PCT/IL2003/000988. As a result there is a considerable blurring of the defects map without blurring the image. An additional advantage is that white and black streaks are eliminated and transformed into different shades of grey that are much easier to correct, as will be described below with respect to FIGS. 14a, 14b.

2. Capturing the printed image using a capture device: A special test pattern or target is printed as illustrated in FIG. 11 and captured using a digital capture device. The capture device may be a line CCD device, a frame CCD device, a scanner, digital camera or any device containing an image capture element.

3. Performing a spatial match between the captured, printed image and the original image file: The captured image is geometrically matched to the original image file. During printing and capturing, various geometrical distortions are added to the captured image; e.g. distortions due to inaccurate motion of the substrate relative to the print head, or due to optical distortions of the capture device. As a result, the captured image no longer matches the original image file. Matching algorithms are known which remove the distortions from the captured image and which perform a very high precision match between the two images.

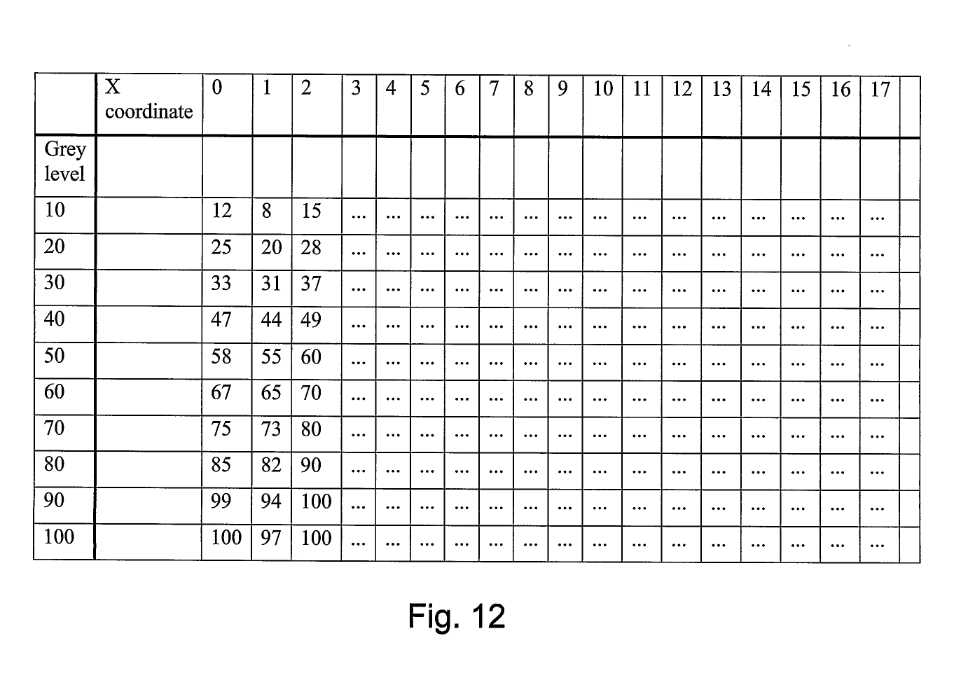

4. Analyzing the variations using a special printed target: The captured image is analyzed. The result of this analysis is a density profile giving the density as a function of the coordinate across the motion direction and of the original printed grey level. This density profile is used for the preparation of a two dimensional lookup table as shown in FIG. 12. This lookup table may be regarded as a tone correction table for each coordinate along the printing array. The basic density profile may also be used for the prediction of corrections for grey levels that have not been actually printed in the target but will be printed in subsequent images. It is important to note that the correction table is independent of the nozzle arrangement.

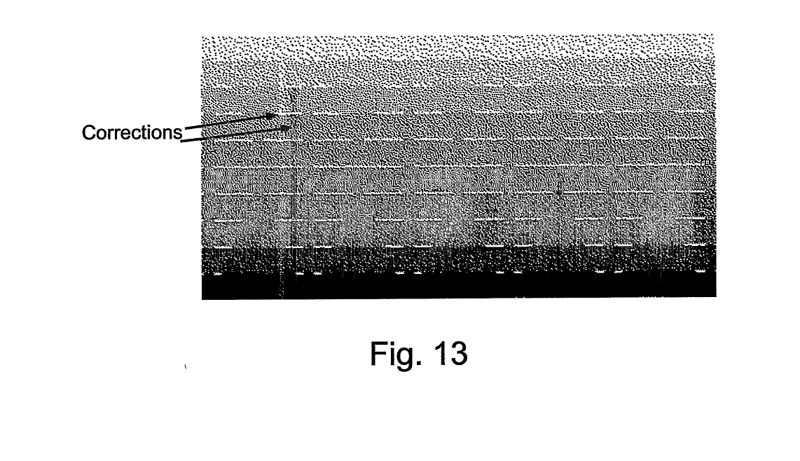

5. Introducing corrections, as shown in FIG. 13, to the following images to be printed: The implementation of the correction is realized by changing the grey levels of the original image prior to printing as a function of the original grey level and of the position of the image relative to the nozzle array. This mechanism is independent of the printer device, i.e. the correction may be performed completely off-line, on any image to be printed.

A flow chart of a preferred method is outlined in FIG. 9.

1. The side shifting mechanism (box 91) is applied for all printing identically.

2. The printed target (box 92) consists of strips of different shades of the printed ink, from no color (blank substrate) to solid color (FIG. 10). It is printed in the normal printing manner of the printer. The result may have density variations along the horizontal X-axis, which is perpendicular to the motion direction Y-axis of the print head relative to the substrate. The printed result is schematically shown in FIG. 11.

3. The printed target is scanned (box 93) right after printing using a capture device, for example, a commercial flat bed scanner or customized Line CCD scanner as described above, with respect to FIG. 3.

4. The captured image is analyzed with the help of matching software to perform a match to the original file. The meaning of the match is an accurate correspondence of each coordinate in the captured image to a coordinate in the original target file. This process is performed using known algorithms.

5. The captured file contains data on the resulting density of the color shades. Based on this data, the software prepares a density profile (box 94), giving for each X-coordinate and color level, a resulting color density, as shown in FIG. 11.

6. For each X-coordinate, the software uses the data on the printed density of each stripe to calculate a tone correction table (box 95). This table gives corrections to the original color levels in order to bring the density of each printed level to a certain desired value. Since the same desired value is used for all X-coordinates, this correction effectively eliminates tone variations along the horizontal axis. The process of calculating the correction tables for each coordinate is a standard process, well known to those skilled in the art.

7. The resulting correction table is shown in FIG. 12. It consists of a delta value for each X-coordinate and grey level. This table can be applied to each image to be printed subsequently. The correction is applied prior to printing (box 96), giving the image a kind of “anti-phase” appearance, compared to the defected printed image, as shown in FIG. 13.

8. The corrected image is then printed (box 97) in the usual process of the printer. This “anti phase” image, when printed in a printing process having the same defects as the target image, results in a relatively smooth image in which density variations across the motion direction have been substantially reduced, as shown in FIGS. 14 and 14b, respectively.

### Accommodating Color Saturation Conditions

A special case in the creation of the correction tables is when there is a color saturation in the dark tones. Saturation occurs when additional ink laid down on the substrate does not result in a darker tone. It is still necessary to produce an accurate correction table when there is saturation since there might be a case where under one set of printing conditions there will be saturation, while under a different set there will be no saturation. Saturation conditions may occur while printing the test pattern, where non saturation images may result under normal working conditions. It is necessary therefore to handle saturation conditions. Saturation is handled as follows as shown by the flow chart of FIG. 15.

1. A saturation condition is identified (box 100). This is done by measuring the printed density of each strip and comparing it to the previous strip. If the difference between them is smaller then some threshold value, then saturation exists. This test is done for each X-coordinate separately (box 101).

2. The saturated strips are ignored and not used to calculate the correction tables; rather, extrapolated values based on the last non saturated color strips, are calculated for each of the saturated strips.

3. The extrapolated values are used along with the non saturated values to calculate the correction tables of FIG. 12, as indicated by boxes 102-105.

4. The resulting correction tables can then be used for any printing conditions whether saturated or not.

While the invention has been described with respect to a preferred embodiment, it will be appreciated that this is set forth merely for purposes of example, and that many other variations, modifications and applications of the invention may be made.

What is claimed is:

1. A method of reducing print-density variations in printers, including printing elements arrayed along the X-axis for printing on a substrate moving relative to the printing elements along the Y-axis, said method comprising:
controlling the printer to print a test pattern including a plurality of strips extending along the X-axis, wherein the gray-level of each printed strip is the same along the X-axis but varies from one strip to the next along the Y-axis;
analyzing said printed test pattern to detect gray-level variations in the printed strips;
preparing a density correction table of gray-level corrections for each X-coordinate;
and controlling said printing elements in accordance with said density correction table to reduce the detected gray-level variations.

2. The method according to claim 1, wherein said density correction table of gray-level corrections includes a delta value for each X-coordinate and gray level.

3. The method according to claim 1, wherein said printer is controlled to print said test pattern such that said plurality of strips vary in gray level from zero to saturation along the Y-axis.

4. The method according to claim 1, wherein said printed test pattern is analyzed by scanning same by means of an optical scanning device.

5. The method according to claim 1, wherein said printer is a multi-deflection, continuous-jet printer in which the printing elements are inkjet nozzles having a side shifting mechanism which is used for printing said test pattern of strips.

6. The method according to claim 1, wherein said printer is a multi-color printer, said test pattern is printed and analyzed for each color, and a said density correction table is prepared for each color.

7. The method according to claim 1, wherein in analyzing said printed test pattern, each of the printed strips is tested for a saturated condition; and where a saturated condition is found to be present, an extrapolated value is included in the density correction table for the respective X-coordinate.

8. The method according to claim 7, wherein each of the printed strips is tested for a saturated condition by determining whether or not the difference in its gray level over that of the preceding strip is greater than a predetermined threshold value.

9. A method of reducing print-density variations in inkjet printers, including a plurality of inkjet nozzles arrayed along the X-axis for printing on a substrate moving relative to the nozzles along the Y-axis, said method comprising the operations:
controlling the inkjet printer to print a test pattern including a plurality of strips extending along the X-axis, wherein the gray-level of each printed strip is the same along the X-axis but varies from one strip to the next along the Y-axis;
analyzing said printed test pattern to detect gray-level variations in the printed strips;
preparing a density correction table of gray-level corrections for each X-coordinate;
and controlling said inkjet nozzles in accordance with said density correction table to reduce the detected gray-level variations.

10. The method according to claim 9, wherein said density correction table of gray-level corrections includes a delta value for each X-coordinate and gray level.

11. The method according to claim 9, wherein said inkjet printer is controlled to print said test pattern such that said plurality of strips vary in gray level from zero to saturation along the Y-axis.

12. The method according to claim 9, wherein said inkjet printer is a multi-deflection, continuous-jet printer in which the printing elements are inkjet nozzles having a side shifting mechanism which is used for printing said test pattern of strips.

13. The method according to claim 9, wherein said inkjet printer is a multi-color printer, said test pattern is printed and analyzed for each color, and a said density correction table is prepared for each color.

14. The method according to claim 9, wherein in analyzing said printed test pattern, each of the printed strips is tested for a saturated condition; and where a saturated condition is found to be present, an extrapolated value is included in the density correction table for the respective X-coordinate.

15. The method according to claim 9, wherein nozzle position errors, angular deflection errors, and phase-shift errors between drop formation signals and data signals, are first corrected before said print-density variations are reduced by said recited operations.

16. A method of reducing print-density variations in inkjet printers, including a plurality of inkjet nozzles arrayed along the X-axis for printing on a substrate moving relative to the nozzles along the Y-axis, said method comprising:
correcting the printer for nozzle position errors, angular deflection errors, and phase-shift errors between drop formation signals and data signals;
controlling the inkjet printer to print a test pattern including a plurality of strips extending along the X-axis, wherein the gray-level of each printed strip is the same along the X-axis but varies from one strip to the next along the Y-axis;
analyzing said printed test pattern to detect gray-level variations in the printed strips;
preparing a density correction table of gray-level corrections for each X-coordinate;
and controlling said inkjet nozzles in accordance with said density correction table to reduce the detected gray-level variations.

17. The method according to claim 16, wherein said density correction table of gray-level corrections includes a delta value for each X-coordinate and gray level.

18. The method according to claim 16, wherein said inkjet printer is controlled to print said test pattern such that said plurality of strips vary in gray level from zero to saturation along the Y-axis.

19. The method according to claim 16, wherein said inkjet printer is a multi-deflection, continuous-jet printer in which the printing elements are inkjet nozzles having a side shifting mechanism which is used for printing said test pattern of strips.

20. The method according to claim 16, wherein in analyzing said printed test pattern, each of the printed strips is tested for a saturated condition; and where a saturated condition is found to be present, an extrapolated value is included in the density correction table for the respective X-coordinate.
